(19) United States
(12) Patent Application Publication
(10) Pub. No.: US 2019/0384269 A1
(43) Pub. Date: Dec. 19, 2019

(54) DEVICE AND METHOD FOR ANALYZING MANUFACTURING APPARATUS

(71) Applicant: UNITED MICROELECTRONICS CORP., Hsinchu (TW)

(72) Inventors: Chih-Ping YEN, Hsinchu City (TW); Te-Sung HUNG, Hsinchu City (TW); Ming-Kuan KAO, Hsinchu City (TW); Ming-Feng WANG, Taipei City (TW); Chieh-Ming CHIU, Hsinchu City (TW); Chin-Hsin HUANG, Tainan City (TW); Pin-Kuei LEE, Tainan City (TW); Chia-Fan TSAI, Kaohsiung City (TW)

(21) Appl. No.: 16/008,114

(22) Filed: Jun. 14, 2018

(51) Int. Cl. G05B 19/418; G06Q 10/08

(52) U.S. Cl. CPC G05B 19/41865; G05B 2219/45031; G06Q 10/087; G05B 19/41875

(57) ABSTRACT

A device and a method for analyzing a manufacturing apparatus are provided. The device includes a storing unit, a detecting unit, a calculating unit and a determining unit. The storing unit is for storing a supply amount of material. The detecting unit is for continuously detecting the manufacturing apparatus once the material is used during whole of a process to obtain a total usage. The calculating unit is for calculating a usage ratio of the total usage to the supply amount. The determining unit is for determining whether the manufacturing apparatus is operated in a usage trouble operation according to the usage ratio.

### TECHNICAL FIELD

The disclosure relates in general to an analyzing device and an analyzing method, and more particularly to a device and a method for analyzing a manufacturing apparatus.

### BACKGROUND

Along with the development of semiconductor technology, various semiconductor products are invented. During the manufacturing process of the semiconductor product, material is supplied to a manufacturing apparatus to perform sputtering, etching, or cleaning.

Please refer to FIG. 1, which shows a material supply system. The material may be supplied from a storage tank 800 to the manufacturing apparatus 900. The flow controller 810 can be used to control the flow of the material MA. A supply amount SA of the material MA is recorded. The detector 910 is disposed on the manufacturing apparatus 900 to measure a production usage PU of the material MA.

However, in the practical application, the production usage UP is far less than the supply amount SA. That is to say, a lot of material MA is wasted during the operation. This phenomenon is happened at most of the manufacturing apparatuses 900, so the manufacturing apparatus 900 which is operated in a usage trouble operation is difficult to be found out.

Further, even if one manufacturing apparatus 900 is deemed as being operated in the usage trouble operation, the waste cause is difficult to be found out. Accordingly, the operation of the manufacturing apparatus 900 operated in the usage trouble operation cannot be adjusted and controlled well.

### SUMMARY

The disclosure is directed to a device and a method for analyzing a manufacturing apparatus. The manufacturing apparatus operated in a usage trouble operation can be found out and a waste cause can be accurately found out. Moreover, the manufacturing apparatus operated in the usage trouble operation can be matched to a manufacturing apparatus operated in a normal operation via an adjusting suggestion and a management index. Therefore, the waste cost can be greatly reduced to obtain huge benefits.

According to one embodiment, a method for analyzing a manufacturing apparatus is provided. The method includes the following steps. A supply amount of material is obtained. The manufacturing apparatus is continuously detected once the material is used during whole of a process to obtain a total usage. A usage ratio of the total usage to the supply amount is calculated. Whether the manufacturing apparatus is operated in a usage trouble operation is determined according to the usage ratio.

According to another embodiment, a device for analyzing a manufacturing apparatus is provided. The device includes a storing unit, a detecting unit, a calculating unit and a determining unit. The storing unit is for storing a supply amount of material. The detecting unit is for continuously detecting the manufacturing apparatus once the material is used during whole of a process to obtain a total usage. The calculating unit is for calculating a usage ratio of the total usage to the supply amount. The determining unit is for determining whether the manufacturing apparatus is operated in a usage trouble operation according to the usage ratio.

### BRIEF DESCRIPTION OF THE DRAWINGS

FIG. 1 (Prior Art) shows a material supply system.

FIG. 2 shows a device for analyzing a manufacturing apparatus.

FIG. 3 shows a flowchart of a method for analyzing the manufacturing apparatus.

FIG. 4 shows an example of the manufacturing apparatus.

FIG. 5 illustrates the usage of the material during an operation of the manufacturing apparatus.

FIG. 6 shows a flowchart of a method for finding out the waste cause.

FIG. 7 shows an example illustrating the steps in FIG. 6.

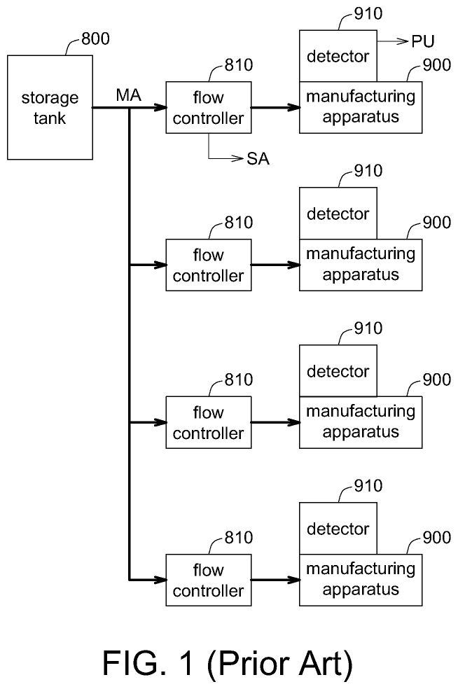

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

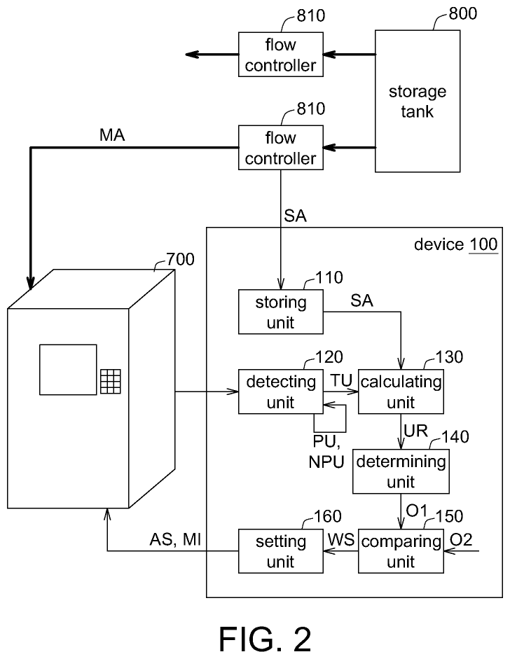

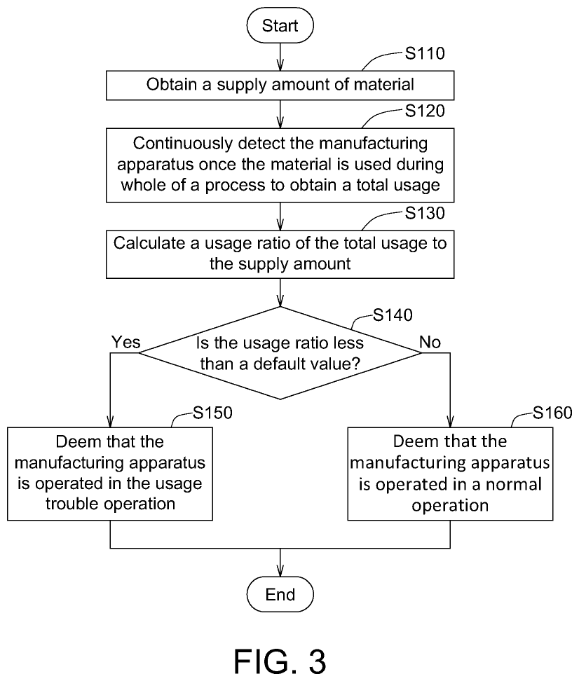

Please refer to FIGS. 2 and 3. FIG. 2 shows a device 100 for analyzing a manufacturing apparatus 700. FIG. 3 shows a flowchart of a method for analyzing the manufacturing apparatus 700. The device 100 of FIG. 2 and the method of FIG. 3 can be used for accurately determining whether the manufacturing apparatus 700 is operated in a usage trouble operation or not. The device 100 includes a storing unit 110, a detecting unit 120, a calculating unit 130, a determining unit 140, a comparing unit 150 and a setting unit 160. The storing unit 110 may be a memory, a hard disk or a could center. The detecting unit 120 may be a flow meter or a sensor. The calculating unit 130, the determining unit 140, the comparing unit 150 and the setting unit 160 may be a circuit, a chip, a circuit board or a storage device storing a plurality of program codes. Those elements are illustrated via the flowchart of FIG. 3.

In step S110, a supply amount SA of material MA is obtained from the storing unit 110. The supply amount SA may be obtained from the flow controller 810 which is used to control the flow of the material MA at the storage tank 800.

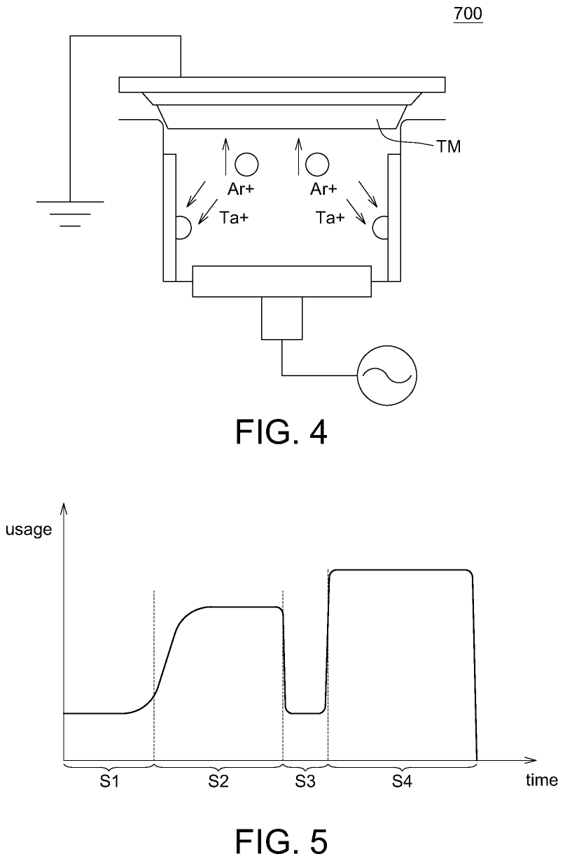

In step S120, the detecting unit 120 continuously detects the manufacturing apparatus 700 once the material MA is used during whole of a process to obtain a total usage TU. In step S120, the total usage TU includes the production usage PU and a non-production usage NPU. For example, please refer to FIGS. 4 and 5. FIG. 4 shows an example of the manufacturing apparatus 700. FIG. 5 illustrates the usage of the material MA during an operation of the manufacturing apparatus 700. The manufacturing apparatus 700 is exemplified as a sputtering apparatus and the material MA is exemplified as the target metal TM. Referring to FIG. 5, the sputtering process may include stages S1 to S5. The stage S1 may be a preparing stage which is a non-production stage, the stage S2 may be a rough sputtering stage which is a production stage, the stage S3 may be an idle stage which is a non-production stage, and the stage S4 may be a meticulous sputtering stage which is a production stage. The production usage PU is detected during the stage S1 and the stage S3, and the non-production usage NPU is detected during the stage S2 and S4. In one embodiment, the manufacturing apparatus 700 is continuously detected every second for obtaining the total usage TU.

In step S130, the calculating unit 130 calculates a usage ratio UR of the total usage TU to the supply amount SA. For example, the usage ratio UR is calculated according to the equation (1).

$$usage ratio UR = \frac{total usage TU}{supply amount SA} \qquad ( 1 )$$

Because the total usage TU includes the non-production usage NPU, the total usage TU is close to the supply amount SA. Therefore, the total usage TU is a useful data to determine whether the manufacturing apparatus 700 is operated in the usage trouble operation or not.

In steps S140 to S160, the determining unit 140 determines whether the manufacturing apparatus 700 is operated in the usage trouble operation according to the usage ratio UR. For example, in the step S140, the determining unit 140 determines whether the usage ratio UR is less than a default value, such as 90%, or not. If the usage ratio UR is less than the default value, then the process proceeds to step S150; if the usage ratio UR is not less than the default value, then the process proceeds to step S160.

In step S150, the determining unit 140 deems that the manufacturing apparatus 700 is operated in the usage trouble operation. In step S160, the determining unit 140 deems that the manufacturing apparatus 700 is operated in a normal operation. Base on above, any manufacturing apparatus operated in the usage trouble operation can be found out to save the wasted material MA.

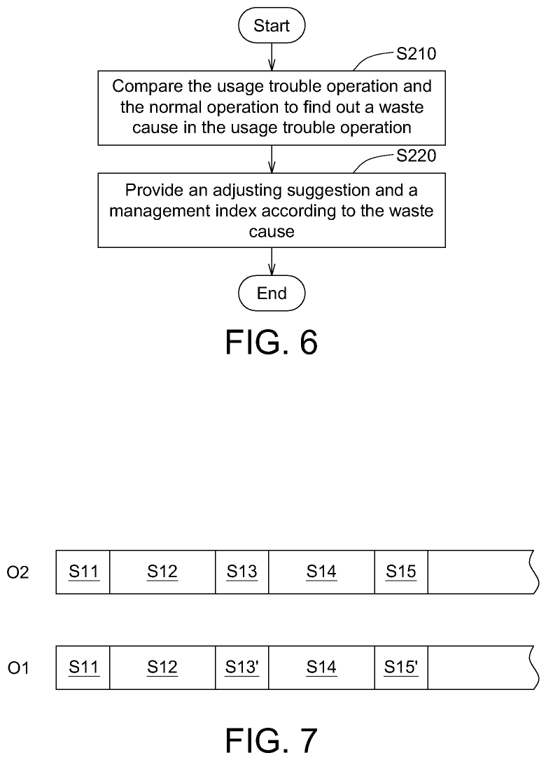

After finding out the manufacturing apparatus operated in the usage trouble operation, the device 100 can further find out a waste cause WS. Please refer FIG. 6 and FIG. 7. FIG. 6 shows a flowchart of a method for finding out the waste cause WS. FIG. 7 shows an example illustrating the steps in FIG. 6. In step S210, the comparing unit 150 compares a usage trouble operation O1 and a normal operation O2 to find out the waste cause in the usage trouble operation O1. In one embodiment, the usage trouble operation O1 and the normal operation O2 are operated by the same manufacturing apparatus, and the normal operation O2 may be selected according to the usage ratio UR. Or, the normal operation O2 may be a simulation operation corresponding an optimal usage ratio.

In FIG. 7, the normal operation O2 includes stages S11, S12, S13, S14, S15, and the usage trouble operation O1 includes stages S11, S12, S13′, S14, S15′. By comparing the usage trouble operation O1 and the normal operation O2, it is found that the stages S13′ and the stage S15′ are different from the stage S13 and the stage S15. Thus, the stage S13′ and the stage S15 are the waste cause WS and are needed to be adjusted.

In step S220, the setting unit 160 provides an adjusting suggestion AS or a management index MI according to the waste cause WS. The adjusting suggestion AS may be the parameters of the manufacturing apparatus 700. According to the adjusting suggestion AS, the parameters in the stages S13′ and the stage S15′ are adjusted. The management index MI may be the termination condition of each stage.

Base on above, the manufacturing apparatus operated in the usage trouble operation can be found out and the waste cause WS can be accurately found out. Moreover, the manufacturing apparatus operated in the usage trouble operation can be matched to the manufacturing apparatus operated in the normal operation via the adjusting suggestion AS and the management index MI. Therefore, the waste cost can be greatly reduced to obtain huge benefits.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for analyzing a manufacturing apparatus, comprising:
obtaining a supply amount of material;
continuously detecting the manufacturing apparatus once the material is used during whole of a process to obtain a total usage;
calculating a usage ratio of the total usage to the supply amount; and
determining whether the manufacturing apparatus is operated in a usage trouble operation according to the usage ratio.

2. The method for analyzing the manufacturing apparatus according to claim 1, further comprising:
deeming that the manufacturing apparatus is operated in the usage trouble operation, if the usage ratio is less than a default value; and
deeming that the manufacturing apparatus is operated in a normal operation, if the usage ratio is not less than the default value.

3. The method for analyzing the manufacturing apparatus according to claim 2, wherein the default value is 90%.

4. The method for analyzing the manufacturing apparatus according to claim 2, further comprising:
comparing the usage trouble operation and the normal operation to find out a waste cause in the usage trouble operation.

5. The method for analyzing the manufacturing apparatus according to claim 4, wherein the usage trouble operation and the normal operation compared with each other are operated by the same manufacturing apparatus.

6. The method for analyzing the manufacturing apparatus according to claim 4, further comprising:
providing an adjusting suggestion according to the waste cause.

7. The method for analyzing the manufacturing apparatus according to claim 4, further comprising:
providing a management index according to the waste cause.

8. The method for analyzing the manufacturing apparatus according to claim 1, wherein the manufacturing apparatus is continuously detected every second for obtaining the total usage.

9. The method for analyzing the manufacturing apparatus according to claim 1, wherein the total usage includes a production usage and a non-production usage.

10. The method for analyzing the manufacturing apparatus according to claim 1, wherein the material is chemical solvent, chemical gas, slurry, or metal target.

11. A device for analyzing a manufacturing apparatus, comprising:
a storing unit for storing a supply amount of material;
a detecting unit for continuously detecting the manufacturing apparatus once the material is used during whole of a process to obtain a total usage;
a calculating unit for calculating a usage ratio of the total usage to the supply amount; and
a determining unit for determining whether the manufacturing apparatus is operated in a usage trouble operation according to the usage ratio.

12. The device for analyzing the manufacturing apparatus according to claim 11, wherein the determining unit deems that the manufacturing apparatus is operated in the usage trouble operation, if the usage ratio is less than a default value; and deems that the manufacturing apparatus is operated in a normal operation, if the usage ratio is not less than the default value.

13. The device for analyzing the manufacturing apparatus according to claim 12, wherein the default value is 90%.

14. The device for analyzing the manufacturing apparatus according to claim 12, further comprising:
a comparing unit for comparing the usage trouble operation and the normal operation to find out a waste cause in the usage trouble operation.

15. The device for analyzing the manufacturing apparatus according to claim 14, wherein the usage trouble operation and the normal operation compared with each other are operated by the same manufacturing apparatus.

16. The device for analyzing the manufacturing apparatus according to claim 13, further comprising:
a setting unit for providing an adjusting suggestion according to the waste cause.

17. The device for analyzing the manufacturing apparatus according to claim 13, further comprising:
a setting unit for providing a management index according to the waste cause.

18. The device for analyzing the manufacturing apparatus according to claim 11, wherein the manufacturing apparatus is continuously detected every second for obtaining the total usage.

19. The device for analyzing the manufacturing apparatus according to claim 11, wherein the total usage includes a production usage and a non-production usage.

20. The device for analyzing the manufacturing apparatus according to claim 11, wherein the material is chemical solvent, chemical gas, slurry, or metal target.
